(19) United States
(12) Patent Application Publication
(10) Pub. No.: US 2014/0228720 A1
(43) Pub. Date: Aug. 14, 2014

(54) PELVIS SUPPORT DEVICE FOR GAIT REHABILITATION ROBOT

(71) Applicant: KOREA INSTITUTE OF SCIENCE AND TECHNOLOGY, Seoul (KR)

(72) Inventors: Seung-Jong Kim, Seoul (KR); Chang Hwan Kim, Seoul (KR); Jun Ho Choi, Seoul (KR); Chan Yul Jung, Bucheon-si (KR)

(73) Assignee: KOREA INSTITUTE OF SCIENCE AND TECHNOLOGY, Seoul (KR)

(21) Appl. No.: 14/146,970

(22) Filed: Jan. 3, 2014

(30) Foreign Application Priority Data
Feb. 12, 2013 (KR) 10-2013-0014849

(51) Int. Cl. A61H 3/00

(52) U.S. Cl. CPC A61H 3/008
USPC 601/35

(57) ABSTRACT

The pelvis support device according to an embodiment of the present disclosure is used for a gait rehabilitation robot having a gait assistance link member connected to the leg of a rehabilitator and includes a support frame, one pair of support bars linearly movable along the longitudinal direction of the support frame, a first driving unit for transmitting power so that the support bar moves along the longitudinal direction of the support frame, a ball screw disposed in each support bar, a movable block coupled to the ball screw and linearly movable along the longitudinal direction of the support bar according to the operation of the ball screw, and a second driving unit for transmitting power to drive the ball screw.

### CROSS-REFERENCE TO RELATED APPLICATION

This application claims priority to Korean Patent Application No. 10-2013-0014849, filed on Feb. 12, 2013, and all the benefits accruing therefrom under 35 U.S.C. §119, the contents of which in its entirety are herein incorporated by reference.

### BACKGROUND

1. Field

The present disclosure relates to a pelvis support device for a gait rehabilitation robot, and more particularly, to a pelvis support device for a gait rehabilitation robot, which assists a rehabilitator to exercise a natural gait pattern without shifting a load of a gait assistance link member connected to the leg of the rehabilitator.

2. Description of the Related Art

A gait rehabilitation robot aids hemiplegic or paraplegic patients, the old of weak physical strength or patient suffering from muscle weakness to train gait without giving a great strain to the leg. The gait rehabilitation robot is classified into a type which a patient directly wears during gait training or daily life and a type which is installed at a treadmill so that a patient repeatedly trains gait.

FIGS. 1 and 2 are diagrams showing a general gait aid support device, which is installed at a treadmill so that a patient may train gait.

Referring to FIGS. 1 and 2, a patient interposes the pelvis between support plates 411, connects the leg to a gait aid 40, and then performs gait training. At this time, in order not to disturb the movement of the pelvis during walking, the rotation plate 410 and the support plate 411 are configured to pivot within a predetermined angle based on a rotary shaft 400.

However, in case of the support device with such a configuration, since a gap between the support plates 411 coupled to both sides of the rotation plate 410 is not adjustable, it is impossible to give satisfactory wearing sensation and stability to patients who have various pelvis sizes.

In addition, since the rotation plate 410 and the support plate 411 may pivot within a predetermined angle based on the rotary shaft 400, a patent may flexibly move the pelvis to some extent. However, since the rotation plate 410 and the support plate 411 move right or left based on a single rotary shaft 400, the right and left movement is limited, and the pelvis interposed between the support plates 411 may be distorted, which makes it impossible to exercise a normal gait pattern.

Therefore, it is demanded to improve the wearing sensation of a patent wearing a gait rehabilitation robot and allows the patent to stably exercise a normal gait pattern when the patent performs rehabilitation training.

### RELATED LITERATURES

### Patent Literature

Korean Patent Registration No. 10-1024033 (PNS Mechanics), published on Mar. 15, 2011

### SUMMARY

The present disclosure is directed to providing a pelvis support device for a gait rehabilitation robot, which may support the pelvis according to various patent body types and replicate natural movement of the pelvis at a gait to perform gait training.

The present disclosure is also directed to providing a pelvis support device for a gait rehabilitation robot, which may allow a rehabilitator to exercise a suitable gait pattern without applying a load of a gait assistance link member connected to the leg.

In one aspect, there is provided a pelvis support device for a gait rehabilitation robot having a gait assistance link member connected to the leg of a rehabilitator, the pelvis support device including: a support frame; one pair of support bars linearly movable along the longitudinal direction of the support frame; a first driving unit for transmitting power so that the support bar moves along the longitudinal direction of the support frame; a ball screw disposed in each support bar; a movable block coupled to the ball screw and linearly movable along the longitudinal direction of the support bar according to the operation of the ball screw; and a second driving unit for transmitting power to drive the ball screw.

A linear guide for guiding linear movement of the support bar may be installed in the support frame.

The pelvis support device may further include a controller for controlling the operations of the first driving unit and the second driving unit.

A gait pattern of the rehabilitator may be stored in the controller in advance or information about the gait pattern may input to the controller, and the controller may operate the first driving unit and the second driving unit in accordance with the gait pattern.

The pelvis support device may further include a pelvis support member having a concave shape so that the pelvis of the rehabilitator is interposed between side ends of the movable block.

The pelvis support member may be partially or entirely made of rubber material.

The pelvis support device for a gait rehabilitation robot according to the present disclosure does not apply an excessive force to the leg and the pelvis of a rehabilitator since it assists gait training of the rehabilitator by replicating movement of the pelvis at a normal gait.

In addition, the pelvis support device for a gait rehabilitation robot according to the present disclosure may allow a rehabilitator to execute a suitable gait pattern by smoothly shifting a center of gravity like a gait of a normal person.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIGS. 1 and 2 are diagrams showing a general gait aid support device.

FIG. 3 is a schematic view showing a gait rehabilitation robot having a pelvis support device according to an embodiment of the present disclosure.

FIG. 4 is a perspective view showing the gait rehabilitation robot having the pelvis support device according to an embodiment of the present disclosure, observed from above.

FIG. 5 is a perspective view showing the gait rehabilitation robot of FIG. 4, observed from below.

FIG. 6 is a diagram showing movement of the pelvis support device according to the present disclosure.

FIG. 7 is a perspective view showing the pelvis support device of FIG. 6, observed from below.

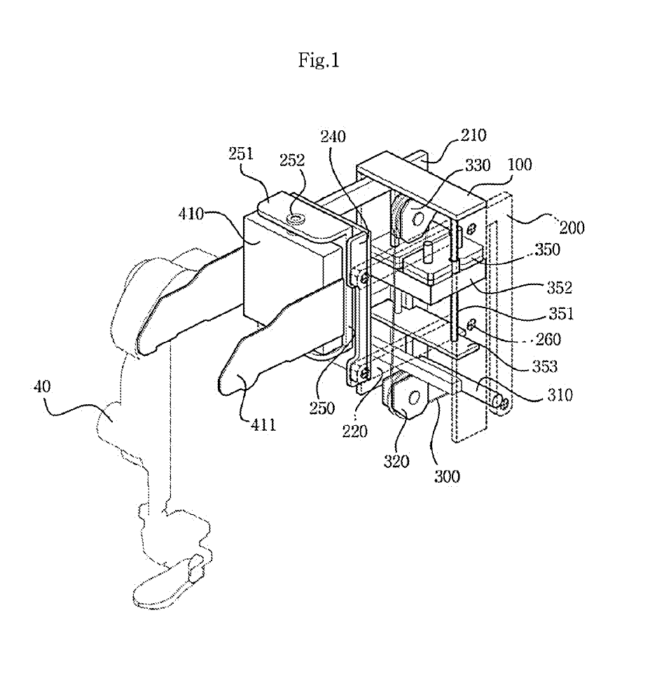

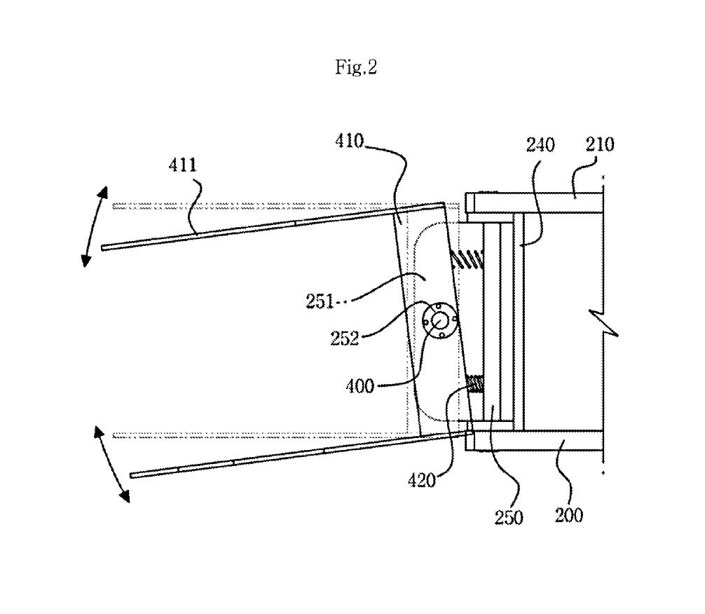

### DETAILED DESCRIPTION OF MAIN ELEMENTS

10: gait rehabilitation robot

20: fixed frame

30: connection link

40: handle

50: support rod

60: gait assistance link member

100: pelvis support device

110: support frame

112: linear guide

120: support bar

122: pelvis support member

124: ball screw

126: movable block

130: first driving unit

140: second driving unit

### DETAILED DESCRIPTION

Hereinafter, a pelvis support device for a gait rehabilitation robot according to an embodiment of the present disclosure will be described in detail with reference to the accompanying drawings.

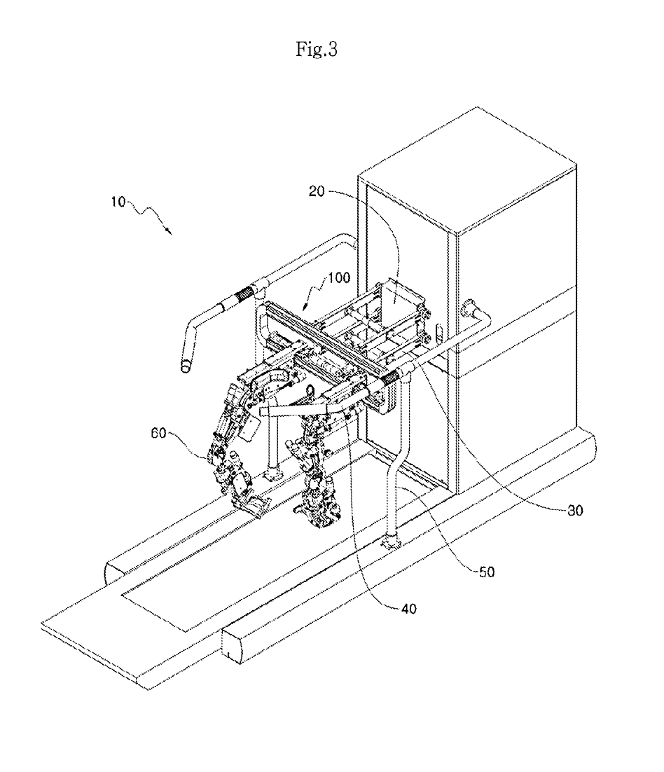

FIG. 3 is a schematic view showing a gait rehabilitation robot having a pelvis support device according to an embodiment of the present disclosure.

Referring to FIG. 3, a gait rehabilitation robot 10 includes a fixed frame 20, a connection link 30, a handle 40, a support rod 50, a gait assistance link member 60 and a pelvis support device 100.

The connection link 30 extends from one side of the fixed frame 20 and transfers loads of the gait assistance link member 60 and the pelvis support device 100 toward the fixed frame 20.

The handle 40 is gripped by a rehabilitator in order to ensure safety during rehabilitation training using the gait rehabilitation robot 10. The support rod 50 fixes a location of the handle 40 and is coupled to a part of the handle 40 in order to burden a load of the rehabilitator.

The gait assistance link member 60 is connected to the leg of the rehabilitator. After connecting the gait assistance link member 60 to the leg, the rehabilitator may perform rehabilitation training by moving the legs according to the movement of the gait assistance link member 60.

Hereinafter, the pelvis support device 100 of the present disclosure for efficiently assisting rehabilitation training will be described in more detail.

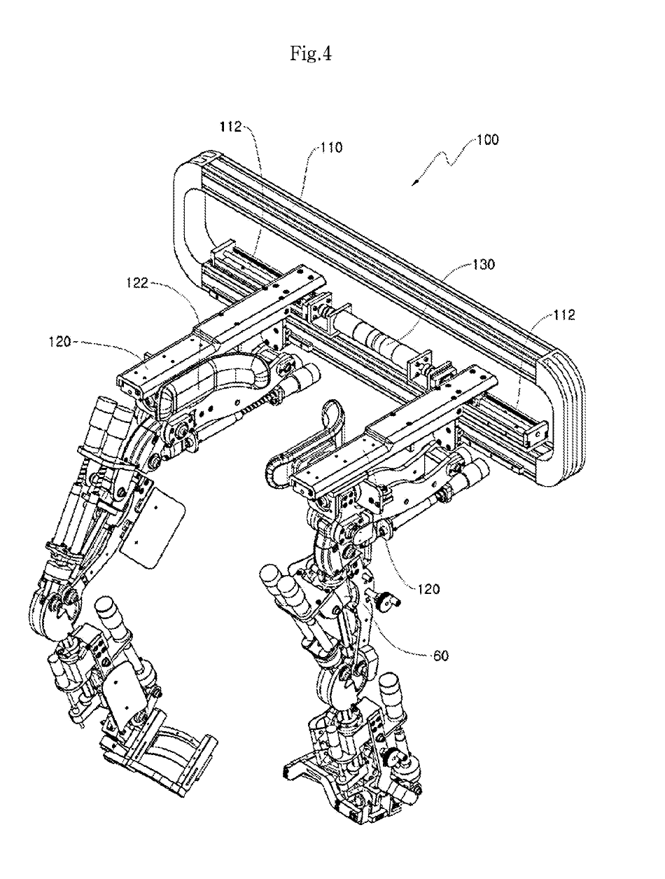

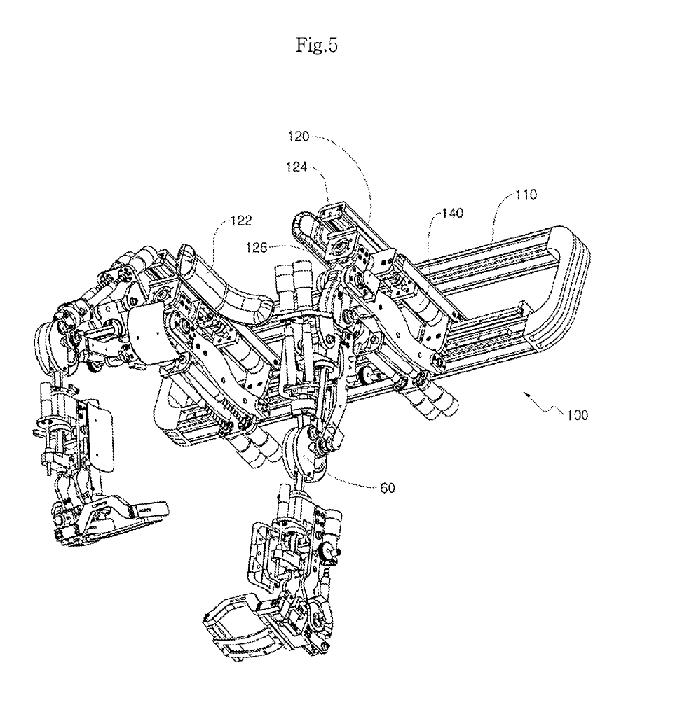

FIG. 4 is a perspective view showing the gait rehabilitation robot having the pelvis support device according to an embodiment of the present disclosure, observed from above, and FIG. 5 is a perspective view showing the gait rehabilitation robot of FIG. 4, observed from below.

Referring to FIGS. 4 and 5, the pelvis support device 100 includes a support frame 110, one pair of support bars 120, a first driving unit 130 and a second driving unit 140.

One end of the support frame 110 is coupled to the connection link 30 of FIG. 3 and transfers the load of the gait assistance link member 60 connected to the support bar 120 toward the connection link 30.

The support frame 110 is depicted as having an open central portion for easier coupling between the connection link 30 and the support bar 120, without being limited thereto.

One pair of support bars 120 is linearly movable along the longitudinal direction of the support frame 110. As the pelvis of the rehabilitator is interposed between the pair of support bars 120, the leg of the rehabilitator is connected to the gait assistance link member 60, thereby completing the preparation for rehabilitation training.

A pelvis support member 122 having a concave shape may be installed in the pair of support bars 120 so that the pelvis of the rehabilitator is interposed therein. In addition, the pelvis support member 122 may be partially or entirely made of rubber material. If the pelvis support member 122 is provided, the wearing sensation of the rehabilitator may be enhanced, and the pelvis support member 122 assists so that the pelvis of the rehabilitator is not distorted, thereby ensuring the rehabilitator to exercise an exact gait pattern.

The first driving unit 130 transmits power so that the support bar 120 moves along the longitudinal direction of the support frame 110. The first driving unit 130 may be configured with a single actuator or with two actuators which operate two support bars 120 individually. If two actuators are provided to operate two support bars 120 individually, a gap between the pair of support bars 120 may be adjusted according to a pelvis size of the rehabilitator. Meanwhile, in order to obtain a greater power, more than two actuators may also be used.

A ball screw 124 is disposed and fixed in each support bar 120. A movable block 126 is coupled to the ball screw 124 and is linearly movable along the longitudinal direction of the support bar 120 according to the operation of the ball screw 124.

The second driving unit 140 transmits power to drive the ball screw 124, and the ball screw 124 converts rotational movement of the second driving unit 140 into linear reciprocation, so that the movable block 126 may linearly reciprocate. The second driving unit 140 may be configured with an actuator respectively installed at the lower portion of the support bar 120, and two or more actuators may also be used to obtain a greater power.

Meanwhile, though not shown in the figures, the pelvis support device 100 of the present disclosure may further include a controller for controlling operations of the first driving unit 130 and the second driving unit 140. According to the control of the controller, the first driving unit 130 and the second driving unit 140 may be individually operated or synthetically operated.

In order to control the first driving unit 130 and the second driving unit 140, a gait pattern of the rehabilitator may be stored in the controller in advance, or information about the gait pattern may be input to the controller. If the information about the gait pattern is analyzed, the movement of the pelvis according to the movement of the leg may be figured out, and the pelvis support member 122 may be moved so that the pelvis of the rehabilitator may naturally move according to the movement of the leg of the rehabilitator connected to the gait assistance link member 60. In other words, the controller may allow the rehabilitator to exercise a natural gait pattern by controlling the first driving unit 130 and the second driving unit 140 based on the information of the gait pattern of the rehabilitator to move the pelvis support member 122.

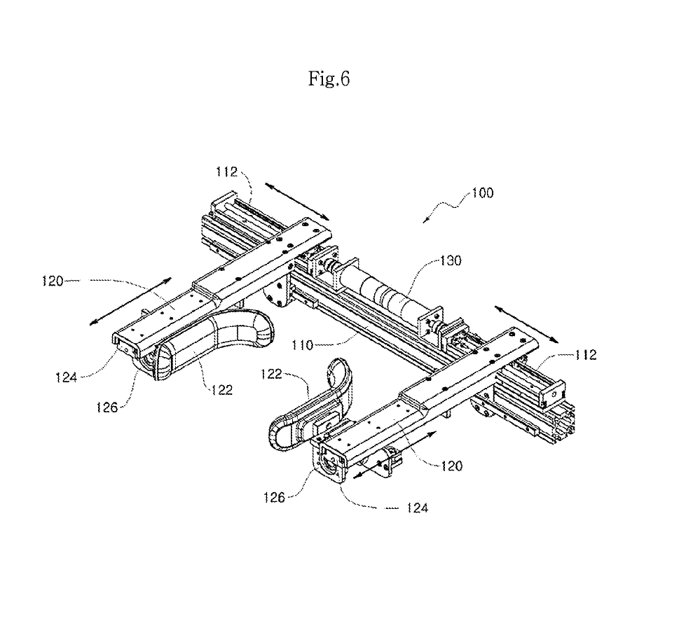

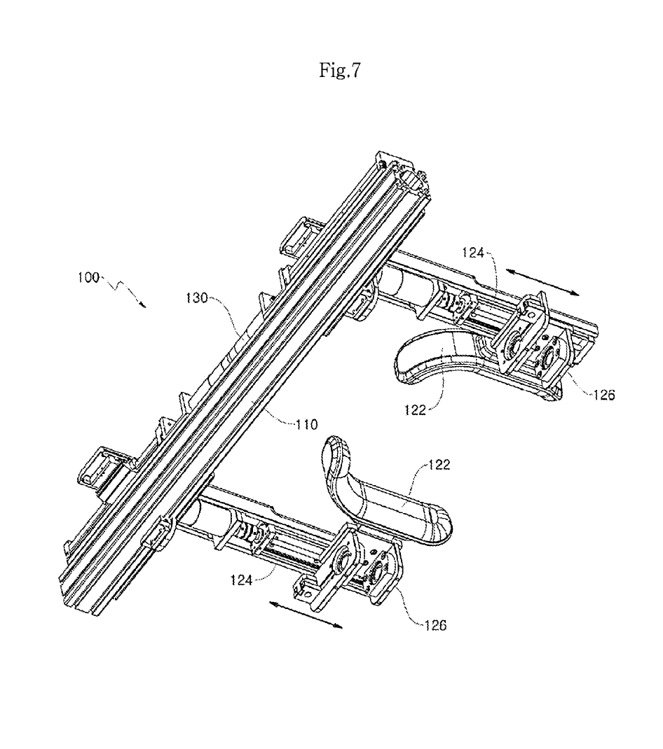

FIG. 6 is a diagram showing movement of the pelvis support device according to the present disclosure, and FIG. 7 is a perspective view showing the pelvis support device of FIG. 6, observed from below.

Referring to FIGS. 6 and 7, the support bar 120 may linearly move in the first direction along the longitudinal direction of the support frame 110 in accordance with the operation of the first driving unit 130. In order to guide the linear movement of the support bar 120 in the first direction, a linear guide 112 may be installed in the support frame 110.

In addition, the ball screw 124 disposed at the lower portion of each support bar 120 may convert the power generated from the second driving unit 140 to move the movable block 126 in the second direction intersecting the first direction, thereby moving the location of the movable block 126. Here, it is also possible to configure so that, if the pelvis support member 122 is installed at the side end of the movable block 126, the gait assistance link member 60 is installed at the lower side thereof, and then the movable block 126 moves in the first direction or the second direction, the pelvis support member 122 and the gait assistance link member 60 also move together.

Though the embodiment of the present disclosure has been described, it will be understood that the present disclosure is not limited thereto, but various changes and modifications can be made based on the claims, the detailed description and the accompanying drawings, which belong to the scope of the present disclosure.

What is claimed is:

1. A pelvis support device for a gait rehabilitation robot having a gait assistance link member connected to the leg of a rehabilitator, the pelvis support device comprising:
a support frame;
one pair of support bars linearly movable along the longitudinal direction of the support frame;
a first driving unit for transmitting power so that the support bar moves along the longitudinal direction of the support frame;
a ball screw disposed in each support bar;
a movable block coupled to the ball screw and linearly movable along the longitudinal direction of the support bar according to the operation of the ball screw; and
a second driving unit for transmitting power to drive the ball screw.

2. The pelvis support device for a gait rehabilitation robot according to claim 1, wherein a linear guide for guiding linear movement of the support bar is installed in the support frame.

3. The pelvis support device for a gait rehabilitation robot according to claim 1, further comprising a controller for controlling the operations of the first driving unit and the second driving unit,
wherein a gait pattern of the rehabilitator is stored in the controller in advance or information about the gait pattern is input to the controller, and the controller operates the first driving unit and the second driving unit in accordance with the gait pattern.

4. The pelvis support device for a gait rehabilitation robot according to claim 1, further comprising a pelvis support member having a concave shape so that the pelvis of the rehabilitator is interposed between side ends of the movable block,
wherein the pelvis support member is partially or entirely made of rubber material to expand or contract due to an external force.
